(19) United States
(12) Patent Application Publication
(10) Pub. No.: US 2002/0096418 A1
(43) Pub. Date: Jul. 25, 2002

(54) Method and device for changing the hold of flat articles being conveyed held by grippers

(75) Inventor: Reinhard Gosslinghof, Wetzikon (CH)

Correspondence Address: RANKIN, HILL, PORTER & CLARK, LLP, 700 HUNTINGTON BUILDING, 925 EUCLID AVENUE, CLEVELAND, OH, 44115-1405, US

(73) Assignee: Ferag AG, Hinwil (CH)

(21) Appl. No.: 10/055,549

(22) Filed: Jan. 23, 2002

(30) Foreign Application Priority Data
Jan. 24, 2001 (CH) 0121/01

(51) Int. Cl. B65G 15/00

(52) U.S. Cl. 198/408

(57) ABSTRACT

Flat articles (3) each held by a feeding-in gripper (5) on a leading first edge are fed-in to a hold changing station (1) one after the other, are pulled onto a changing support situated in the changing station (1) and are deposited on it by opening the feeding-in gripper (5). Each deposited article is then pushed across the changing support (10) by a conveying-away gripper (6) and while being pushed is grasped by closing the conveying-away gripper (6) and is conveyed away held gripped on a second edge. Advantageously the feeding-in direction (Z) and the conveying-away direction (W) intersect above the changing support (10) under the one angle (_{α}), which is also constituted by the first and the second edge. For the hold change of rectangular printed products, the angle (_{α}) amounts to 90°. For pushing the articles, the conveying-away grippers (6) move in the plane of the surface of the changing support and are driven from below. For articles (3) which overlap one another on being fed-in, the feeding-in grippers (5) move above the surface of the changing support (10) and are driven from above. The hold changing operation can be implemented with simpler means than known hold changing operations. Nonetheless the security and the accuracy, with which the change is carried out are satisfactory for most requirements.

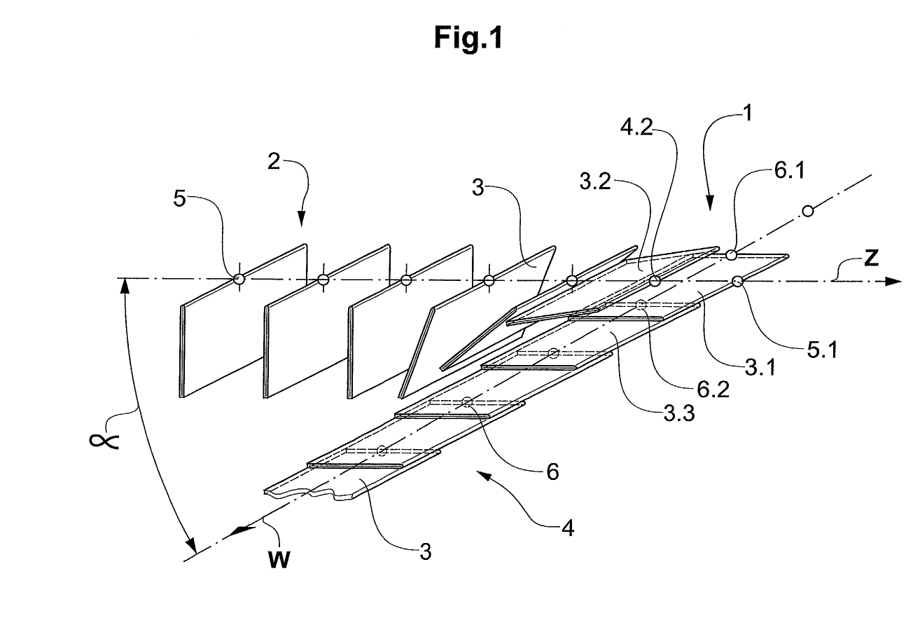

(FIG. 1)

The invention is situated in the field of materials handling technology and is related to a method and a device for changing the hold of flat articles being conveyed held in a gripped manner, in particular for changing the hold of printed products being conveyed one after the other in an e.g. continuous stream, wherein every flat object or printed product is held by a gripper in an edge zone.

Changing the hold is to be understood as a process, in which every one or a predetermined selection of articles each being conveyed in a held manner by a first gripper is taken over by a second gripper, wherein the first gripper grips the article in a first edge zone and the second gripper grips the article in a second edge zone different from the first one.

A device for changing the hold of printed products conveyed in a held manner is known, for example, from the publication EP-0305671 (or U.S. Pat. No. 4,893,805). This device comprises a feeding-in device and a conveying-away device, both of which comprise a traction organ and grippers arranged thereon. The feeding-in device supplies the printed products in a substantially freely suspended manner, i.e., gripped in an upper edge zone. Upstream of the changing station, the lower part of the freely suspended printed products is guided onto a supporting surface and in this manner is retarded relative to the gripped edges. This means that the products are brought into an inclined position in such a manner, that their lower edges trail behind the gripped upper edges. They reach the changing station being such inclined. In the area of the changing station, the grippers of the conveying-away device move along a track below the conveying track of the feeding-in device and aligned to it. The movements of the grippers of the feeding-in device and of conveying-away device are parallel and synchronized in such a manner, that, at the changing station, every gripper of the conveying-away device meets with a lower edge zone of a printed product being fed-in and is capable of grasping it. The actuation of the grippers of the two conveying devices is synchronized in such a way, that the conveying-away gripper is closed before the feeding-in gripper is opened, such that there is no moment in which the product is not gripped. The feeding-in gripper is opened as rapidly as possible after the closing of the conveying-away gripper.

Devices in accordance with the mentioned publication have the advantage, that conveyance of the printed products through the changing station is continuous and always guided in a precisely defined manner and that nonetheless at no moment in time the printed products are strained between the two grippers. The device therefore provides a very high conveyance security and is therefore applicable for highly sensitive printed products. These advantages, however, are achieved only if the feeding-in and conveying-away and the gripper actuation are exceedingly accurately synchronized. Furthermore, the changing process is limited to a change from a hold on one edge to a hold on the opposite edge or from a hold of one zone to another zone of the same edge and the device is dependent on the format of the products. Furthermore, the change demands a fairly long, substantially parallel conveyance of the feeding-in and conveying-away grippers, this in particular, if the conveying-away grippers have to catch up with the trailing edges of the products in order to position these edges in the gripper mouths.

For changing the hold on a first edge of a printed product to a hold on a second edge perpendicular to the first edge according to prior art, a conveying stream of gripped printed products is transformed into an imbricated stream, in which the products are lying loosely on a conveying surface, this imbricated stream is turned around by 90° or the individual products are turned around by 90° and the products are thereupon gripped again by conveying-away grippers. Because product guidance in an imbricated stream is less accurate than in a gripped stream, the security and the precision of such a method are significantly lower than in the case of a direct hold changing operation. A device, in which an imbricated stream is turned around, is disclosed, for example, in the publication CH-617408 (or U.S. Pat. No. 4,201,377).

It is the object of the invention to create a method and a device for changing the hold of flat articles being conveyed in a held manner, which method and device on the one hand are to be simpler than corresponding methods and devices according to prior art and nonetheless are not to be subject to their limitations. Therefore, using the method and device according to the invention it shall be possible to feed-in the flat articles held gripped in a first edge zone and to convey them away held gripped in a second edge zone, the two edges being oriented at right angles or at an oblique angle. The method and the device according to the invention shall provide a security and hold accuracy satisfying very high demands also in the case of very high conveying capacities.

In accordance with the method according to the invention, the flat articles are held by feeding-in grippers in a leading edge zone and they are pulled one after the other onto a changing support. They are positioned one after the other on the changing support by opening each gripper and every article deposited on the changing support is pushed off the support by an open conveying-away gripper before the next article is deposited, the conveying-away gripper acting on trailing edge zone different form the edge zone being acted on by the feeding-in gripper. During the pushing action, the conveying away gripper is closed while the article is still being held in a stable position by the changing support. The pushing movement and the conveying-away take place in one direction (conveying-away direction), which intersects with the feeding-in direction in the area of the changing station.

The pushing action can be effected as mentioned above by the conveying-away grippers. It can also be effected by other suitable pushing means, such as, for example, pusher cams. Independent of the pushing means, the articles are grasped by the conveying-away grippers while being pushed. However, if pushing means different form the conveying-away grippes are used it becomes possible to grasp the articles in an edge zone different from the edge zone being acted on by the pushing means.

Before the conveying-away gripper is closed, the articles if so required can be subjected to lateral alignment.

For a high conveying capacity and nonetheless relatively low conveying speed it is advantageous, if the articles overlap one another both during the feeding-in as well as during the conveying-away. In this case, the articles are arranged in the feeding-in stream in such a manner, that their gripped, leading edges are on top of the stream. In the conveying-away stream the leading edges are on top of the stream also, however, they are not the gripped edges.

The projections of the feeding-in direction and of the conveying-away direction on the surface of the changing support intersect under an angle, which advantageously corresponds to the angle between the edges held on feeding-in and the edges held on conveying-away. This signifies, that for rectangular articles being fed-in gripped at a longer edge and being conveyed away gripped at a shorter edge, the angle between the two conveying directions advantageously amounts to 90°.

It becomes manifest, in particular when utilising the invention for conveying printed products, that also in the case of very high conveying capacities and very dense conveying streams, e.g. for distances between products of approx. 10 cm at edge lengths of up to approx. 60 cm and for conveying speeds of up to approx. 1 to 2 m/sec it is possible, to carry out the hold changing process in accordance with the invention with an adequate security and accuracy, wherein the demands of the synchronisation accuracy between feeding-in and conveying-away are significantly lower than is the case with known systems for hold changing. Furthermore, the dependence of the device on article format is significantly lower, than has been the case up until now. As long as the edge zone held gripped during feeding-in and the edge zone acted on on pushing (i.e., for rectangular or square-shaped products one product corner), can be aligned to a reference position, the device does not have to be modified nor readjusted for handling products of differing formats.

The device according to the invention comprises a feeding-in device with feeding-in grippers, a conveying-away device with conveying-away grippers and a changing support. The conveying-away device may further comprise separate pushing means. The changing support is arranged horizontally or inclined. The two conveying devices are arranged in such a manner, that their grippers are driven from opposite sides, for example, one set of them from above, the other one from below. For the pushing function, the conveying-away grippers or the pushing means respectively move advantageously substantially in the plane of the surface of the changing support and are driven from below. For this purpose, the changing support comprises at least two independent parallel parts, between which the grippers move driven from below. It is also possible to provide gripper pairs driven from below, of which one gripper respectively moves on each side of the changing support which in this case is narrower than the handled articles.

If the articles overlap one another in the feeding-in stream and in the conveying-away stream, the feeding-in grippers being driven from above move above the changing support and at a distance from it. If the articles do not overlap, the feeding-in grippers may move in the same plane as the conveying-away grippers and the grippers of the two kinds traverse each other's paths in a comb-like manner.

The two conveying devices comprise e.g. conveying organs, on which the grippers are arranged at equal distances or they comprise rail tracks, along which conveying elements with one gripper each are conveyed in a more or less independent manner. For synchronizing grippers arranged on conveying elements being independent of one another, the conveying elements need to be brought into phase for the hold changing process.

For opening and closing the grippers in the zone of the changing support, e.g. actuating cams are provided and the grippers comprise corresponding control rollers rolling along the cams. If not all the fed-in articles are to be subjected to the hold changing operation the grippers need to be selectively controlled.

The feeding-in device advantageously further comprises a means for braking the fed-in articles after being released from the feeding-in grippers. Such braking means keep the articles from overshooting the changing support due to their own momentum.

In the zone of the changing support there are advantageously aligning means being aligned in the direction of the conveying-away. These aligning means serve for laterally aligning the articles deposited on the changing support while being released by the feeding-in gripper and/or while being pushed across the changing support by the conveying-away grippers or the pushing means.

Method and device in accordance with the invention are described in more detail on the basis of the following Figures, wherein:

FIG. 1 is a three-dimensional illustration of a feeding-in stream and a conveying-away stream of flat articles, which in a hold changing station being operated according to the invention are released from feeding-in grippers and are taken over by conveying-away grippers;

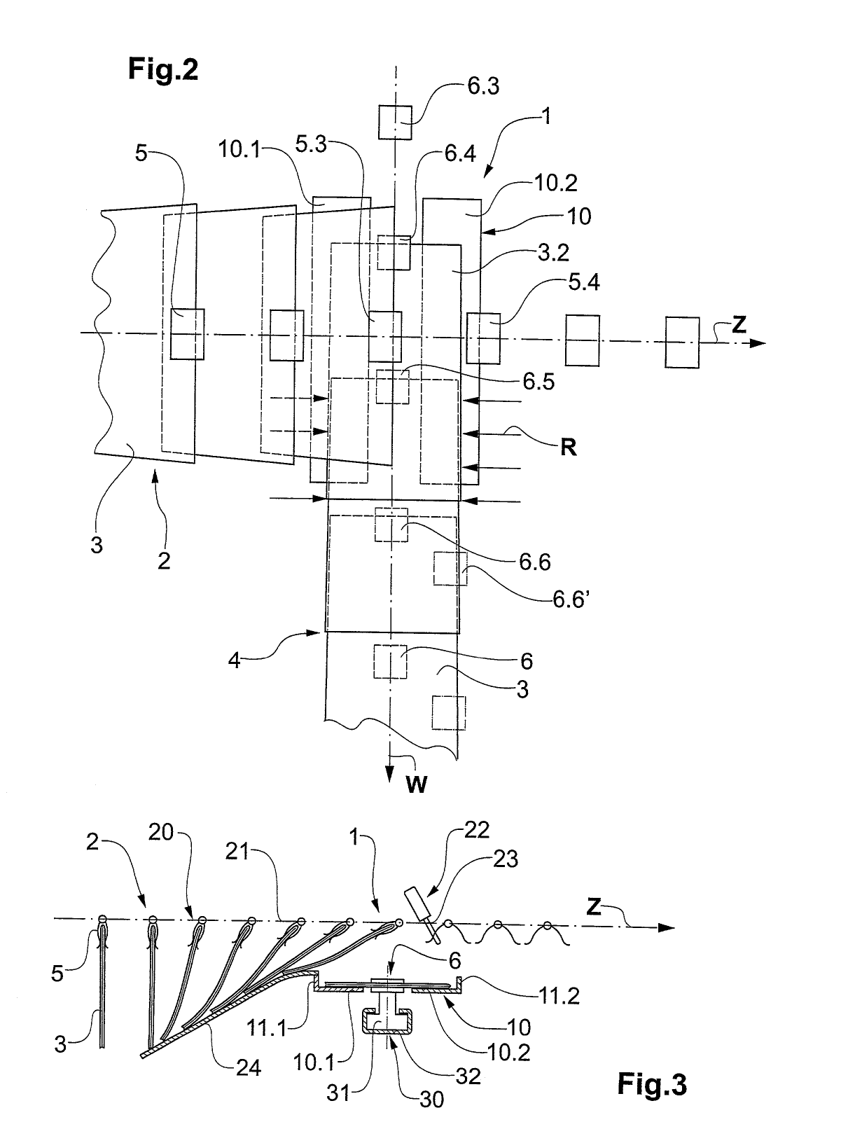

FIG. 2 is a view from above onto a schematically illustrated, exemplary embodiment of the device according to the invention;

FIG. 3 shows an exemplary embodiment of the device according to the invention (viewing direction essentially parallel to the changing support and transverse to the feeding-in direction);

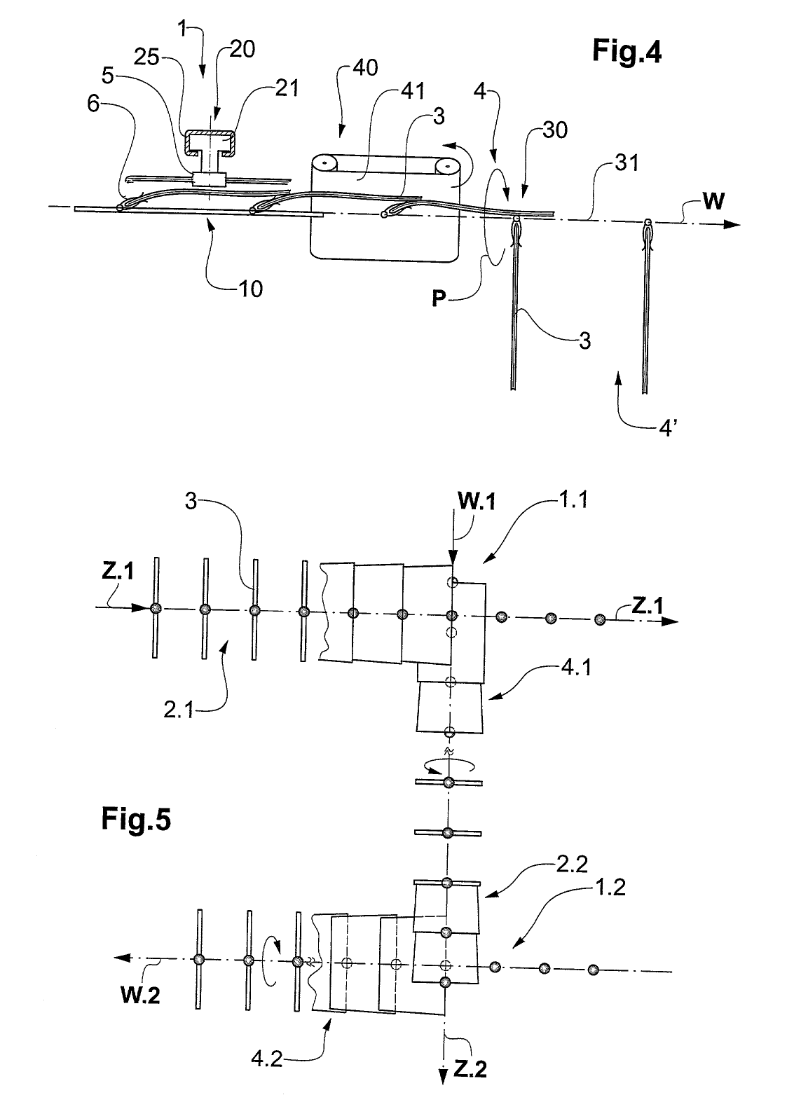

FIG. 4 shows an exemplary embodiment of the device in accordance with the invention (viewing direction essentially parallel to the changing support and transverse to the conveying-away direction);

FIG. 5 shows a combination of two hold changing stations operated according to the invention.

FIG. 1 is a very schematic, three-dimensional illustration of a hold changing station 1 being operated in accordance with the invention. A feeding-in stream 2 of flat articles 3 is fed-in to the station in a feeding-in direction Z and is transformed into a conveying-away stream 4 of articles being gripped and conveyed away in a conveying-away direction. The articles 3 are e.g. rectangular and are fed-in held at their longer edges and conveyed away held at their shorter edges or vice versa. The longer and shorter edges are at right angles to one another. The feeding-in direction Z and the conveying-away direction W are advantageously in parallel planes at a distance from one another and their projections onto the plane of the conveying away direction (surface of the changing support) intersect at a corresponding angle _{α}of 90°.

The feeding-in grippers 5 grip the articles at their upper edges and convey them, for example, freely suspended towards the hold changing station 1. Upstream of the hold changing station 1, the lower edges of the articles 3 are retarded in such a manner, that the upper gripped edges become the leading edges. In this position the articles 3 are pulled onto a not illustrated changing support and are released by the feeding-in gripper, as soon as they have reached a predefined position relative to the changing support. On being released, the articles if so required drop onto the changing support the dropping distance being as short as possible.

FIG. 1 depicts the article 3.1 at a moment, in which it is being released by the feeding-in gripper 5.1, in order to be pushed immediately afterwards in the conveying-away direction W by the conveying-away gripper 6.1. If the articles 3 in the feeding-in stream 2 and in the conveying-away stream 4 overlap, the article 3.1 being pushed across the changing support by the conveying-away gripper 6.1 is partially covered by the following article 3.2 being pulled onto the changing support or on the article 3.1 respectively by a further feeding-in gripper 4.2 and a preceding article 3.3 is pushed across the changing support by a further conveying-away gripper 6.2 underneath the article 3.1. The further conveying-away gripper 6.2 is advantageously already closed in the moment of time depicted.

At least immediately before being deposited on the changing support, the articles 3 in the feeding-in stream 2 have leading edges lying on top of the stream and are held by the grippers at these leading edges. In the conveying-away stream 4, they also have leading edges lying on top of the stream, now, however, they are held at the trailing edges lying on the bottom side of the stream. In order to transform the conveying-away stream 4 into a conveying stream, in which the articles are once again conveyed in a suspended manner, the conveying-away grippers 6 are e.g. rotated by 180° around the conveying away direction W in an as such known manner (refer to FIG. 4).

FIG. 2 illustrates an exemplary embodiment of the device in accordance with the invention from a bird's eye view. The hold changing process which can be implemented with this device corresponds substantially to the process as depicted in FIG. 1. Identical parts are designated with the same reference numbers as in FIG. 1. FIG. 2 also shows the changing support, which in the case presented here consists of two parallel parts 10.1 and 10.2 distanced from one another. The feeding-in grippers 5 move above the changing support 10. The conveying-away grippers 6 move in the zone of the surface of the changing support, i.e. through the clearance between the parallel parts 10.1 and 10.2 and they protrude above the surface of the changing support. The conveying paths of the feeding-in grippers and of the conveying-away grippers can also intersect, if synchronisation is such, that the two gripper types do not interfere with one another.

Of the feeding-in grippers 5, the gripper 5.3 is still closed, the gripper 5.4 is already opened. Of the conveying-away grippers 6, the grippers 6.3 and 6.4 are open, 6.5 open or closed and 6.6 closed. The arrows R indicate lateral aligning means for laterally aligning the downstream part of an article 3.2 being pushed across the changing support 10.

As mentioned further above, instead of the conveying-away grippers 6 separate pushing means moved in the same manner (e.g., pusher cams) may be utilised for the pushing function. Such pushing means protrude above the surface of the changing support 10 and are driven from below. In such a case, the pushing means designated as 6.3, 6.4 and 6.5 in FIG. 2 would therefore not be grippers, but e.g. pusher cams and instead of by the grippers designated as 6.6 and 6, the articles to be conveyed away would be grasped laterally by conveying-away grippers 6.6′ and 6′ (indicated with dot-dash lines) being laterally displaced relative to the pusher cams, and they would be conveyed away without changing the conveying-away direction. The conveying-away grippers 6.6′ and 6′ co-operating with the pusher cams my hold one article each or several articles overlapping one another.

FIGS. 3 und 4 show further exemplary embodiments of the device according to the invention viewed substantially parallel to the changing support 10, in FIG. 3 transverse to the feeding-in direction Z, in FIG. 4 transverse to the conveying-away direction W.

FIG. 3 depicts the feeding-in device 20, which as conveying organ (dot-dash line 21) comprises a chain or a multitude of conveying elements displaceable along a rail track. The feeding-in grippers 5 are arranged on the feeding-in organ 21 and are capable of being swivelled relative to it parallel to the feeding-in direction Z. Furthermore, there is a braking means 22, e.g. comprising two brake bars 23 capable of being run out and into the feeding-in stream 2 on both sides of the feeding-in grippers 5. The breaking means serve for braking an article 3 to be subjected to the changing process in such a manner, that it is deposited on the changing support 10 as accurately as possible.

The conveying-away device 30 of FIG. 3 is illustrated in a section transverse to the conveying-away direction (orientated towards the viewer). It comprises a conveying organ 31, e.g. a chain or a multitude of conveying elements, which conveying organ is guided within a channel 32. The channel 32 is arranged underneath the changing support 10 in such a way, that the conveying-away grippers 6 extend above the surface of the changing support 10 and act on articles 3, which are lying on the surface of the changing support.

The changing support 10 comprises two parallel parts 10.1 and 10.2 distanced from one another and aligned in the conveying-away direction and it is equipped on the feeding-in side with a running-up ramp 24 which serves for retarding the lower edges of the fed-in articles 3 relative to their upper edges.

The changing support 10 further comprises upwards facing rims 11.1 and 11.2 directed upwards and extending on both sides in the conveying-away direction. Articles 3 released by the feeding-in grippers 5 are guided laterally between these rims on being deposited on the changing support 10 and on being pushed across the changing support 10.

FIG. 4 illustrates essentially the same embodiment of the device in accordance with the invention as FIG. 3, this time viewed transverse to the conveying-away direction W. The feeding-in device 20 is sectioned transverse to the feeding-in direction (oriented towards the viewer). In the same manner as the conveying-away device 30 of FIG. 3, the feeding-in device comprises guided within a channel 25 a conveying organ 21, on which the feeding-in grippers are arranged. Of the conveying-away device 30 the conveying organ 31 (as a dot-dash line) and conveying-away grippers 6 are illustrated, the conveying-away grippers being designed for swivelling parallel to the conveying-away direction W.

FIG. 4 also shows a further, exemplary means 40 for the lateral alignment of the preceding parts of articles 3 during deposition on the changing support 10 and/or during their pushed movement across the changing support 10. This alignment device 40 comprises two circulating belts 41, each of which is arranged on one side of the conveying-away direction. The belts 41 are driven in circulation in such a manner, that their part directed against the articles 3 moves in the conveying-away direction and has substantially the same speed as the conveying-away grippers 6.

In the conveying away-stream 4 established during the hold changing operation, articles 3 overlap one another and have leading edges lying on top of the stream. By rotating (arrow P) the conveying-away grippers 6 around the conveying organ 31, this conveying-away stream 4 can be transformed into a further conveying away-stream 4′, in which the articles 3 are conveyed essentially freely suspended. Such rotation is possible only at a distance from the changing support 10.

FIG. 5 shows in a similar representation as FIG. 2 a combination of two hold changing stations 1.1 and 1.2 operated according the invention. The articles 3 are fed-in as described above, in a first feeding-in stream 2.1 in essence freely suspended and at the first hold changing station 1.1, they are subjected to a first hold changing operation of the kind as shown in FIG. 1. The first conveying-away stream 4.1 in which the articles are conveyed away from the station with trailing gripped edges lying on the bottom side of the stream is transformed by rotation by 180° around the first conveying-away direction W.1 into a second feeding-in stream 2.2, in which the articles 3 are conveyed once again essentially freely suspended. The second feeding-in stream 2.2 is subjected at the second hold changing station 1.2 to a second hold changing operation and thereby is transformed into a second conveying-away stream 4.2. In the second conveying-away stream 4.2, the articles are gripped on edges opposite the edges gripped in the first feeding-in stream 2.2.

FIG. 5 gives the impression, that at both hold changing stations 1.1 and 1.2 all articles are subjected to the hold changing operation. This, however, is not a condition. At every hold changing station 1.1 and 1.2 it is possible to take only selected ones of the articles from the feeding-in stream 2.1 and 2.2 and to convey the articles remaining in the feeding-in stream e.g. to one or more further hold changing stations. This signifies, that there may be a plurality of hold changing stations along the conveying path of the feeding-in grippers, the conveying-away direction at each hold changing station being idependently selectable. The conveying-away directions may e.g. be parallel to one another or opposed to one another. A device with a plurality of hold transfer stations may e.g. be utilised for splitting streams or capacities.

1. Method for changing the hold of flat articles (3) being conveyed in a held manner, the method comprising the steps of:
Feeding-in the articles one after the other in a feeding-in direction (z) to a hold changing station (1), the articles being held by feeding-in grippers (5) in a leading first edge zone,
pulling each article onto a changing support (10) situated in the hold changing station (1),
depositing each article on the changing support (10) by opening the corresponding feeding-in gripper (5),
pushing the deposited article across the changing support (10) in the conveying-away direction (w) with the aid of a conveying-away gripper (6) or another pushing means acting on the articles (3) in a trailing second edge zone,
taking hold of the article while it is being pushed by closing the pushing conveying-away gripper (6) around the trailing second edge zone or a conveying-away gripper arranged laterally of the pushing means around a lateral third edge zone,
and conveying away the articles one after the other in the conveying-away direction (w),
wherein the feeding-in direction (z) and the conveying-away direction (w) intersect in the area of the hold changing station.

2. Method in accordance with claim 1 characterized in that the first edge and the second edge of the articles (3) form an angle (_{α}) and that the projections of the feeding-in direction (Z) and the conveying-away direction (W) intersect under the same angle on the surface of the changing support (10).

3. Method according to claim 2, characterized in that the angle (_{α}) is a right angle.

4. Method in accordance with claim 1, characterized in that the articles (3) overlap one another during the feeding-in and are conveyed with their leading edges situated on the upper surface of the stream and that the feeding-in grippers (5) are moved above the changing support (10) and at least in the area of the changing support (10) are driven from above.

5. Method according to claim 4, characterized in that for being conveyed away, the articles (3) overlap one another and have their leading edges situated at the upper side of the stream and that the conveying-away grippers (6) or pushing means are moved essentially in the plane of the surface of the changing support (10) and at least in the area of the changing support (10) are driven from below.

6. Method in accordance with claim 5, characterized in that the conveying-away grippers (6) together with the articles to be conveyed away are rotated by 180° around the conveying-away direction (W) after leaving the area of the changing support (10).

7. Method according to claim 1, characterized in that the articles (3) are pushed across the changing support (10) by pushing means and that while being pushed they are taken hold of by the conveying-away grippers (6.6′. 6′) in edge zones being aligned parallel to the conveying-away direction.

8. Method in accordance with claim 1, characterized in that the articles are laterally aligned on being deposited on the changing support (10) and/or on being pushed across the changing support (10).

9. Method according to claim 1, characterized in that the articles (3) are braked following the opening of the feeding-in grippers (5).

10. Device for changing the hold of flat articles (3) being conveyed in a held manner, the device comprising:
a feeding-in device (20) with feeding-in grippers (5) for the held feeding-in of articles (3) in a feeding-in direction (Z) to a hold changing station (1),
a conveying-away device (30) with conveying-away grippers (6) for the held conveying-away of the articles (3) in a conveying-away direction (W) from the hold changing station (1),
control means for opening the feeding-in grippers (5) and for closing the conveying-away grippers (6) in the area of the hold changing station (1),
and a changing support (10) situated at the hold changing station (1),
wherein the feeding-in device (20), the conveying-away device (30) and the changing support (10) are arranged for the feeding-in direction (Z) and the conveying-away direction (W) to lead across the surface of the changing support and to intersect,
and wherein conveyance of the feeding-in grippers (5) and of the conveying-away grippers (6) is synchronized and the control means are designed for the feeding-in grippers (5) to be opened, when a held article (3) has reached a predefined position on the changing support (10), for the conveying-away grippers (6) or other pushing means moving in the conveying-away direction to reach an edge zone of the article (3), when the article is deposited on the changing support (10) and for the conveying-away grippers (6) to be closed while the article (3) is being pushed across the changing support (10).

11. Device in accordance with claim 10, characterized in that the feeding-in device (20) and the conveying-away device (30) are arranged in such a manner, that the projections of the feeding-in direction (Z) and of the conveying-away direction (W) intersect on the surface of the changing support (10) under an angle (_{α}) of 90°.

12. Device according to claim 10, characterized in that the changing support (10) comprises at least two parallel parts (10.1 and 10.2) aligned in the conveying-away direction (W) and at a distance from one another and that the conveying-away device (30) is designed and arranged in such a manner, that the conveying-away grippers (6) move substantially in the plane of the surface of the changing support (10) and are driven through the space between the parallel parts (10.1 and 10.2).

13. Device in accordance with claim 10, characterized in that the changing support (10) comprises at least two parallel parts (10.1 and 10.2) aligned in the conveying-away direction (W) and at a distance from one another, that the device further comprises pushing means protruding above the surface of the changing support (10) and driven through the space between the two parallel parts (10.1 and 10.2) to move in the conveying-away direction (W) and that the conveying-away device (30) is arranged in such a manner, that the conveying-away grippers (6) are laterally displaced relative to the pushing means.

14. Device according to claim 12, characterized in that, at least within the area of the hold changing station (1), the feeding-in device (20) is designed and arranged in such a manner, that the feeding-in grippers (5) move above the surface of the changing support and are driven from above.

15. Device in accordance with claim 10, characterized in that the control means are control cams and that the feeding-in and/or the conveying-away grippers (5, 6) comprise control rollers rolling along the control cams.

16. Device according to claim 10, characterized in that on its feeding-in side, the changing support (10) comprises a running-up ramp (24) for retarding lower parts of articles (3) being fed-in in a suspended manner.

17. Device in accordance with claim 10, characterized in that it further comprises alignment means (11.1, 11.2, 40) for laterally aligning at least the leading parts of the articles (3) on being deposited on the changing support (10) and/or on being pushed across the changing support (10).

18. Device according to claim 10, characterized in that it further comprises a braking means (22) for braking the articles (3), when they are released by the feeding-in grippers (5).

19. Use of the method in accordance with claim 1 or of the device according to claim 10 for changing the hold of rectangular printed products from a longer edge to a shorter edge or vice versa.
